(19) United States
(12) Patent Application Publication
(10) Pub. No.: US 2025/0226143 A1
(43) Pub. Date: Jul. 10, 2025

(54) ARRAY-TYPE POWER INDUCTOR AND SWITCHING POWER SUPPLY SYSTEM DEVICE

(71) Applicant: Murata Manufacturing Co., Ltd., Kyoto-fu (JP)

(72) Inventor: Tatsuya HOSOTANI, Nagaokakyo-shi (JP)

(73) Assignee: Murata Manufacturing Co., Ltd., Kyoto-fu (JP)

(21) Appl. No.: 19/096,096

(22) Filed: Mar. 31, 2025

Related U.S. Application Data
(63) Continuation of application No. PCT/JP2023/038302, filed on Oct. 24, 2023.

(30) Foreign Application Priority Data
Oct. 27, 2022 (JP) 2022-172046

(51) Int. Cl. H01F 27/24; H01F 1/34; H01F 27/29; H02M 3/155

(52) U.S. Cl. CPC H01F 27/24; H01F 1/344; H01F 27/29; H02M 3/155

(57) ABSTRACT

An array-type power inductor includes main conductors whose number is at least two and which have a linear three dimensional structure and individually constitute a plurality of inductors, the linear three dimensional structure being non-spiral; a magnetic body which includes a magnetic material and forms a magnetic path of a magnetic flux, the magnetic flux being generated by currents flowing through the main conductors; and a plurality of external terminals which are arranged in an outside of the magnetic body and are electrically connected to the plurality of respective main conductors. The main conductors are arranged in parallel with each other with a structure in which there is the magnetic body in an adjacent inside of each of the main conductors. The external terminals are connected to a power conversion circuit in an outside so that directions of the currents flowing through the main conductors are the same.

### CROSS-REFERENCE TO RELATED APPLICATIONS

This application claims benefit of priority to International Patent Application No. PCT/JP2023/038302, filed Oct. 24, 2023, and to Japanese Patent Application No. 2022-172046, filed Oct. 27, 2022, the entire contents of each are incorporated herein by reference.

### BACKGROUND

### Technical Field

The present disclosure relates to an array-type power inductor including a plurality of power inductors.

### Background Art

U.S. Pat. No. 7,352,269 describes an inductor including two linear windings, a U-shaped magnetic core, and an I-shaped magnetic core.

The two linear windings are sandwiched between the U-shaped magnetic core and the I-shaped magnetic core and arranged in parallel with each other. There is no magnetic body between the two linear windings, but there is a gap.

In such a configuration, a large negative mutual inductance is obtained by causing currents to flow in the two linear windings in opposite directions.

### SUMMARY

However, in the configuration of U.S. Pat. No. 7,352,269, when currents are applied to the two linear windings in the same direction, magnetic fluxes cancel each other in a magnetic path in a central portion between the two linear windings. As a result, magnetic flux density is reduced, and the inductance is accordingly reduced.

When inductance is small, an effective value of an inductor current increases. Therefore, when this inductor is applied to a power conversion system, the power loss of the conduction loss in the power conversion system increases and the output voltage ripple increases, deteriorating the power supply quality.

Accordingly, the present disclosure provides an array-type power inductor which can arbitrarily adjust self-inductance and mutual inductance and can achieve miniaturization of a magnetic component while obtaining large inductance.

An array-type power inductor according to the present disclosure includes a plurality of main conductors whose number is at least two and which have a linear three dimensional structure and individually constitute a plurality of inductors, the linear three dimensional structure being non-spiral; a magnetic body which is made of a magnetic material and forms a magnetic path of a magnetic flux, the magnetic flux being generated by currents flowing through the plurality of main conductors; and a plurality of external terminals which are arranged in an outside of the magnetic body and are electrically connected to the plurality of respective main conductors. The plurality of main conductors are arranged in parallel with each other with a structure in which there is the magnetic body in an adjacent inside of each of the plurality of main conductors. The plurality of external terminals are connected to a power conversion circuit in an outside so that directions of the currents flowing through the plurality of main conductors are the same as each other. The magnetic body includes an inner leg portion which is positioned on an inner side and to which the plurality of main conductors are adjacent, and an outer leg portion which is positioned on an outer side and to which the plurality of main conductors are not adjacent. The inner leg portion has a first gap which forms a first magnetic path for a magnetic flux passing through the inner leg portion in magnetic fluxes generated when a current flows through one of the main conductors. The outer leg portion has a second gap which forms a second magnetic path for a magnetic flux passing through the outer leg portion without passing through the inner leg portion in magnetic fluxes generated when a current flows through one of the main conductors. A magnetic body structure is provided which creates a physical phenomenon in which magnetic fluxes generated when currents flow through the plurality of main conductors in a same direction cancel each other in the inner leg portion and strengthen each other in the outer leg portion, and in which magnetic resistance formed by a second gap is larger than magnetic resistance formed by the first gap and an entire structure is integrated including the inner leg portion, the outer leg portion, the first gap, and the second gap. A structure in which the plurality of inductors are integrated is provided.

In this configuration, there is the magnetic body in the inner leg portion, the gap is formed in each of the inner leg portion and the outer leg portion, and the magnetic resistance of the outer leg portion that affects the self-inductance and the magnetic resistance of the inner leg portion that affects the coupling inductance are appropriately set by the gap.

According to the present disclosure, the self-inductance and the mutual inductance can be arbitrarily adjusted, and the composite magnetic component including a plurality of inductances in an array form can be miniaturized while obtaining a large inductance by controlling the magnitude of the magnetic flux density in the magnetic material to suppress magnetic saturation. Further, by arbitrarily setting the number of main conductors corresponding to winding and the number of inner leg portions of the magnetic body corresponding to the core, an array-type power inductor having a small scalable structure including a magnetic body structure in which the entire structure is integrated can be realized, and scalable correspondence can be made in accordance with a power specification of a power conversion circuit. This exhibits advantageous effects that an inductor structure does not have to be designed for each power specification and a development period and a design period of the switching power supply device can be shortened. In addition, in the development and design of the power conversion circuit, it is not necessary to prepare various inductors based on structures individually designed to meet power specifications, and it is possible to simplify manufacturing management and inventory management of an inductor and to simplify the evaluation of electrical characteristics of the inductor. Thus, the switching power supply device can be improved in efficiency and performance, and can be reduced in cost and improved in reliability in quality.

### BRIEF DESCRIPTION OF THE DRAWNGS

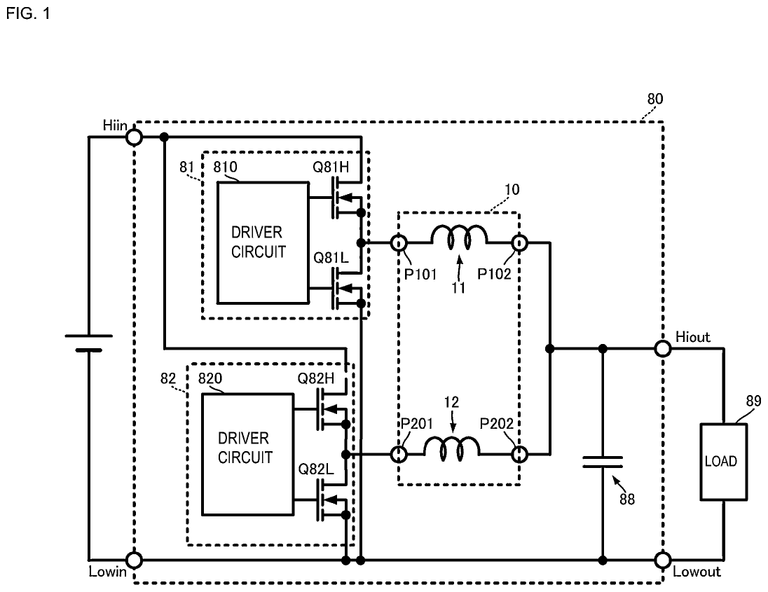

FIG. 1 is an equivalent circuit diagram of a switching power supply system device according to a first embodiment of the present disclosure;

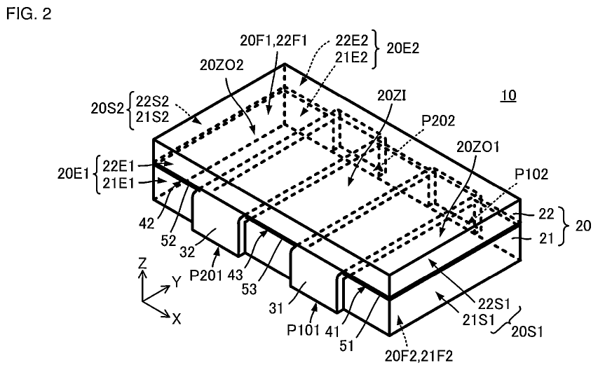

FIG. 2 is an external perspective view of an array-type power inductor according to the first embodiment of the present disclosure;

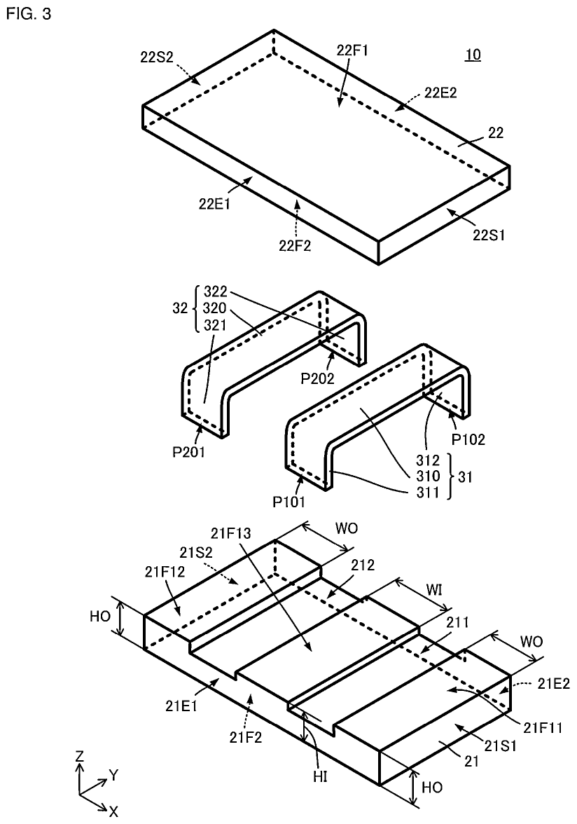

FIG. 3 is an exploded perspective view of the array-type power inductor according to the first embodiment of the present disclosure;

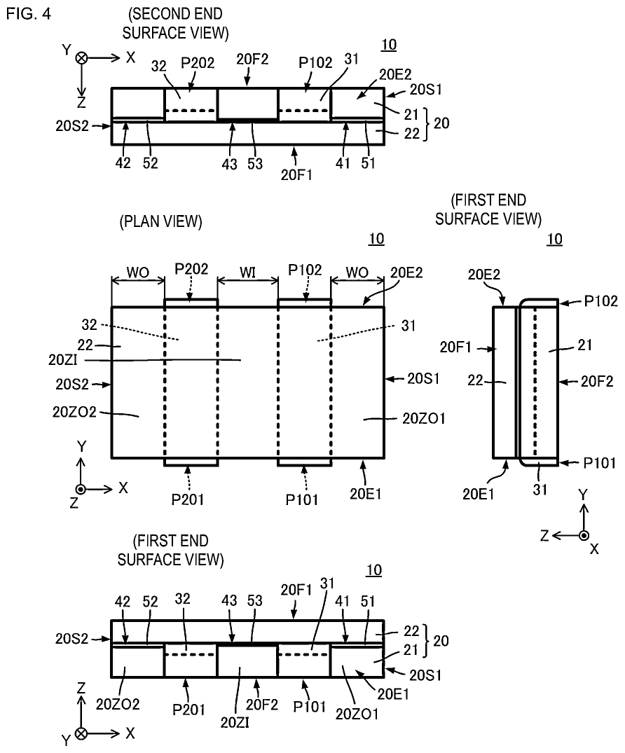

FIG. 4 is a four-sided view of the array-type power inductor according to the first embodiment of the present disclosure;

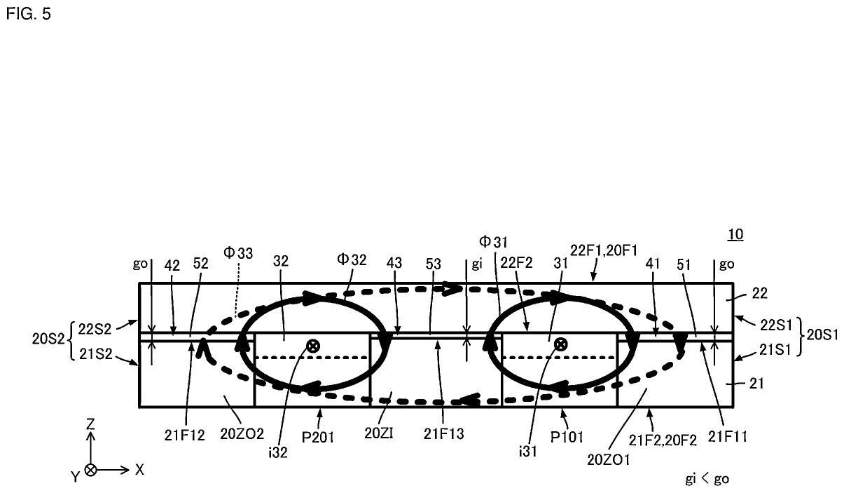

FIG. 5 is an enlarged side view showing an example of states of currents and magnetic fluxes in the array-type power inductor according to the first embodiment;

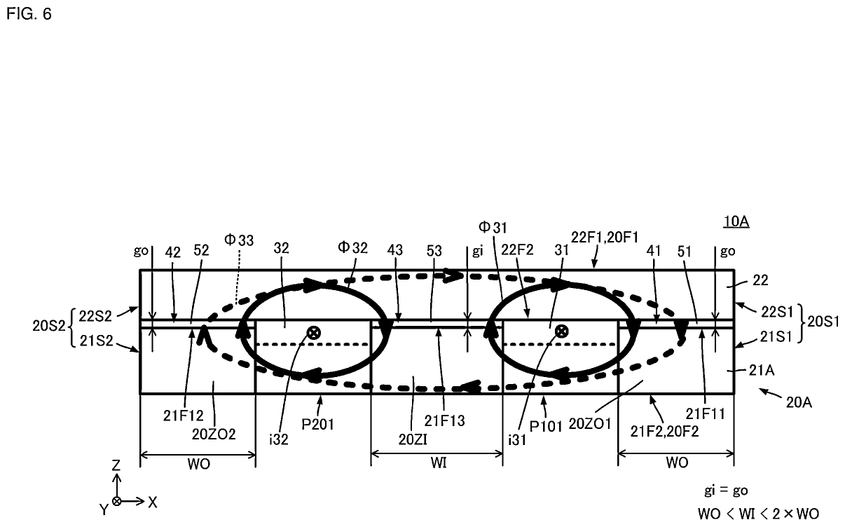

FIG. 6 is an enlarged side view showing an example of a configuration of an array-type power inductor according to a second embodiment of the present disclosure and states of currents and magnetic fluxes in the same;

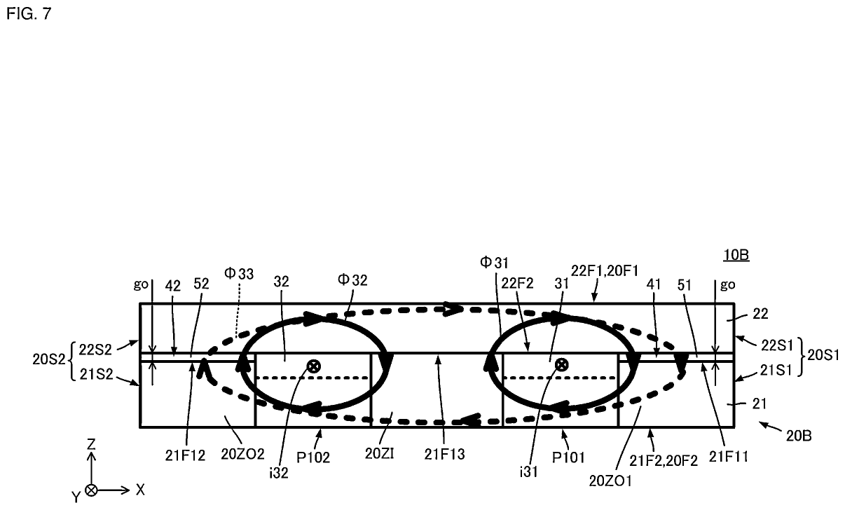

FIG. 7 is an enlarged side view showing an example of a configuration of an array-type power inductor according to a third embodiment of the present disclosure and states of currents and magnetic fluxes in the same; and

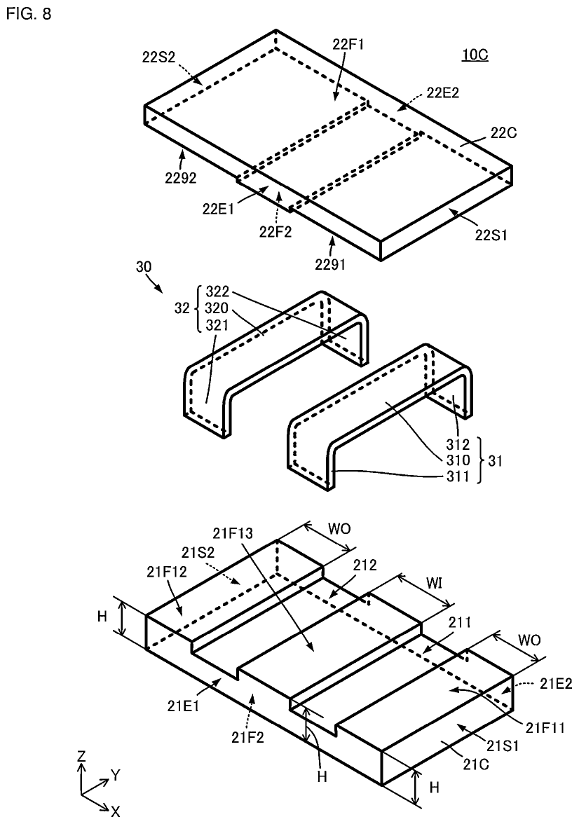

FIG. 8 is an exploded perspective view of an array-type power inductor according to a fourth embodiment of the present disclosure.

### DETAILED DESCRIPTION

### First Embodiment

An array-type power inductor and a switching power supply system device according to a first embodiment of the present disclosure will be described with reference to the drawings.

### (Circuit Configuration of Switching Power Supply System Device Including Array-Type Power Inductor)

FIG. 1 is an equivalent circuit diagram of the switching power supply system device according to the first embodiment of the present disclosure. As shown in FIG. 1, a switching power supply system device 80 includes an array-type power inductor 10, a power semiconductor IC 81, a power semiconductor IC 82, and a capacitor 88.

The power semiconductor 81 includes a driver circuit 810, a switching element Q81H, and a switching element Q81L. The power semiconductor 82 includes a driver circuit 820, a switching element Q82H, and a switching element Q82L. The switching element Q81H, the switching element Q81L, the switching element Q82H, and the switching element Q82L are power semiconductor elements, and are, for example, power MOSFETs.

The array-type power inductor 10 includes an inductor 11 and an inductor 12. The array-type power inductor 10 includes a first input terminal P101, a second input terminal P201, a first output terminal P102, and a second output terminal P202.

A DC power supply is connected between a Hi-side power supply input terminal and a Low-side power supply input terminal of the switching power supply system device 80. The Hi-side power supply input terminal is connected to a positive pole of the DC power supply, and the Low-side power supply input terminal is connected to a negative pole of the DC power supply.

The driver circuit 810 is connected to a gate terminal of the switching element Q81H and a gate terminal of the switching element Q81L.

A drain terminal of the switching element Q81H is connected to the Hi-side power supply input terminal of the switching power supply system device 80. A source terminal of the switching element Q81H is connected to a drain terminal of the switching element Q81L. A source terminal of the switching element Q81L is connected to the Low-side power supply input terminal of the switching power supply system device 80 (a terminal connected to a reference potential line). The reference potential line connects the Low-side power supply input terminal of the switching power supply system device 80 (a terminal connected to the negative pole of the DC power supply) and a Low-side output terminal of the switching power supply system device 80 (a terminal connected to a negative pole of a load 89).

A node between the source terminal of the switching element Q81H and the drain terminal of the switching element Q81L is connected to the first input terminal P101 of the array-type power inductor 10. The first input terminal P101 is connected to one terminal of the inductor 11. The other terminal of the inductor 11 is connected to the first output terminal P102. Here, one terminal of the inductor 11 may be the first input terminal P101, and similarly, the other terminal of the inductor 11 may be the first output terminal P102.

The power semiconductor 81 (the driver circuit 810, the switching element Q81H, and the switching element Q81L) and the inductor 11 constitute a first power conversion circuit.

The driver circuit 820 is connected to a gate terminal of the switching element Q82H and a gate terminal of the switching element Q82L.

A drain terminal of the switching element Q82H is connected to the Hi-side power supply input terminal of the switching power supply system device 80. A source terminal of the switching element Q82H is connected to a drain terminal of the switching element Q82L. A source terminal of the switching element Q82L is connected to the Low-side power supply input terminal of the switching power supply system device 80 (a terminal connected to the reference potential line).

A node between the source terminal of the switching element Q82H and the drain terminal of the switching element Q82L is connected to the second input terminal P201 of the array-type power inductor 10. The second input terminal P201 is connected to one terminal of the inductor 12. The other terminal of the inductor 12 is connected to the second output terminal P202. Here, one terminal of the inductor 12 may be the second input terminal P201, and similarly, the other terminal of the inductor 12 may be the second output terminal P202.

The power semiconductor 82 (the driver circuit 820, the switching element Q82H, and the switching element Q82L) and the inductor 12 constitute a second power conversion circuit.

The first output terminal P102 and the second output terminal P202 are connected to each other, and the node therebetween is connected to the Hi-side output terminal of the switching power supply system device 80.

The capacitor 88 is a smoothing capacitor, and is connected between the Hi-side output terminal and the Low-side output terminal connected to the reference potential line.

With the above configuration, the switching power supply system device 80 includes the first power conversion circuit and the second power conversion circuit which are connected in parallel. Here, the number of power conversion circuits connected in parallel is not limited to two. The number of power conversion circuits each including an inductor is set in accordance with a current required by the load 89 which is an external electric circuit. Thus, the switching power supply system device 80 having a scalable structure can be realized.

### (Array-Type Power Inductor)

FIG. 2 is an external perspective view of the array-type power inductor according to the first embodiment of the present disclosure. FIG. 3 is an exploded perspective view of the array-type power inductor according to the first embodiment of the present disclosure. FIG. 4 is a four-sided view of the array-type power inductor according to the first embodiment of the present disclosure. FIG. 4 shows a plan view (a view of a surface opposite to a mounting surface), a first end surface view, a second end surface view, and a first side surface view. In the drawings, three orthogonal axes are referred to as an X axis, a Y axis, and a Z axis, but these are axis names used for ease of description, and do not limit, for example, the direction of the array-type power inductor 10 during use.

As shown in FIGS. 2, 3, and 4, the array-type power inductor 10 includes a magnetic body 21, a magnetic body 22, a main conductor 31, and a main conductor 32.

### (Magnetic Body 21)

The magnetic body 21 is a so-called E-shaped core.

The magnetic body 21 has a main plane 21F11, a main plane 21F12, a main plane 21F13, a main plane 21F2, an end surface 21E1, an end surface 21E2, a side surface 21S1, and a side surface 21S2. The main plane 21F11, the main plane 21F12, and the main plane 21F13 are opposed to the main plane 21F2 and the main planes 21F11, 21F12, 21F13, and 21F2 are orthogonal to the Z-axis direction (thickness-wise direction of the magnetic body 21).

The magnetic body 21 has a groove 211 and a groove 212 which are formed to extend in the Y-axis direction. The groove 211 and the groove 212 are formed with an interval therebetween in the X-axis direction (the longitudinal direction of the magnetic body 21). The grooves 211 and 212 are formed in the magnetic body 21, and thus the main plane 21F11, the main plane 21F13, and the main plane 21F12 are formed.

The end surface 21E1 and the end surface 21E2 are opposed to each other, are parallel to the X-axis direction (the long side direction of the magnetic body 21 in the present embodiment), and are orthogonal to the Y-axis direction (the short side direction of the magnetic body 21 in the present embodiment). The side surface 21S1 and the side surface 21S2 are opposed to each other, are parallel to the Y-axis direction, and are orthogonal to the X-axis direction.

An end surface 21E1 and an end surface 21E2 connect the main plane 21F11, the main plane 21F12, and the main plane 21F13 with the main plane 21F2. The side surface 21S1 and the side surface 21S2 connect the main plane 21F11, the main plane 21F12, and the main plane 21F13 with the main plane 21F2, and connect the end surface 21E1 with the end surface 21E2.

Thus, the magnetic body 21 realizes an E-shaped core which is surrounded by the front side main plane composed of the main plane 21F11, the main plane 21F12, the main plane 21F13, and the main plane 21F2, the main plane 21F2 on the back side, the end surface 21E1, the end surface 21E2, the side surface 21S1, and the side surface 21S2, and has the groove 211 and the groove 212.

A distance between the main plane 21F11 and the main plane 21F2, that is, a height HO of a portion corresponding to a first outer leg portion in the magnetic body 21, is equal to a distance between the main plane 21F12 and the main plane 21F2, that is, a height HO of a portion corresponding to a second outer leg portion in the magnetic body 21.

A distance between the main plane 21F13 and the main plane 21F2, that is, a height HI of a portion corresponding to an inner leg portion in the magnetic body 21 is greater than the height HO of the portions corresponding to the first outer leg portion and the second outer leg portion.

### (Magnetic Body 22)

The magnetic body 22 is a flat plate and is a so-called I-shaped core. The magnetic body 22 includes a main plane 22F1, a main plane 22F2, an end surface 22E1, an end surface 22E2, a side surface 22S1, and a side surface 22S2. The main plane 22F1 and the main plane 22F2 are opposed to each other, the end surface 22E1 and the end surface 22E2 are opposed to each other, and the side surface 22S1 and the side surface 22S2 are opposed to each other.

### (Magnetic Body 20)

A magnetic body 20 is formed by combining the magnetic body 21 and the magnetic body 22 with each other.

The magnetic body 22 is arranged on the side having the main planes 21F11, 21F12, and 21F13 of the magnetic body 21. At this time, the main plane 22F2 of the magnetic body 22 faces the main planes 21F11, 21F12, and 21F13 of the magnetic body 21.

The magnetic body 21 and the magnetic body 22 are fixed by adhesives 51, 52, and 53 interposed between the main planes 21F11, 21F12, and 21F13 of the magnetic body 21 and the main plane 22F2 of the magnetic body 22.

The magnetic body 20 composed of the magnetic body 21 and the magnetic body 22 is thus formed. The end surface 21E1 of the magnetic body 21 and the end surface 22E1 of the magnetic body 22 are substantially flush with each other, and the end surface 21E2 of the magnetic body 21 and the end surface 22E2 of the magnetic body 22 are substantially flush with each other. The side surface 21S1 of the magnetic body 21 and the side surface 22S1 of the magnetic body 22 are substantially flush with each other, and the side surface 21S2 of the magnetic body 21 and the side surface 22S2 of the magnetic body 22 are substantially flush with each other.

Thus, the magnetic body 20 is a substantially rectangular parallelepiped having a main plane 20F1 (composed of the main plane 22F1), a main plane 20F2 (composed of the main plane 21F2), an end surface 20E1 (composed of the end surface 21E1 and the end surface 22E1), an end surface 20E2 (composed of the end surface 21E2 and the end surface 22E2), a side surface 20S1 (composed of the side surface 21S1 and the side surface 22S1), and a side surface 20S2 (composed of the side surface 21S2 and the side surface 22S2).

With this configuration, the magnetic body 20 includes a first outer leg portion 20ZO1 formed on the side surface 20S1 side from the portion where the groove 211 is formed, an inner leg portion 20ZI formed between the portion where the groove 211 is formed and the portion where the groove 212 is formed, and a second outer leg portion 20ZO2 formed on the side surface 20S2 side from the portion where the groove 212 is formed (see FIG. 2).

A width WO of the first outer leg portion 20ZO1 and a width WO of the second outer leg portion 20ZO2 are the same as each other. A width WI of the inner leg portion is larger than or equal to the widths WO of the first outer leg portion 20ZO1 and the second outer leg portion 20ZO2, and are smaller than or equal to twice the widths WO of the first outer leg portion 20ZO1 and the second outer leg portion 20ZO2.

Here, thicknesses of the adhesives 51 and 52 are substantially the same as each other, and a thickness of the adhesive 53 is smaller than the thicknesses of the adhesives 51 and 52. Magnetic permeability of the adhesives 51, 52, and 53 is lower than magnetic permeability of the magnetic body 21 and magnetic permeability of the magnetic body 22.

Thus, a magnetic gap 41 (second gap) having a height (gap width) go is formed between the main plane 21F11 and the main plane 22F2, that is, in the first outer leg portion 20ZO1. A magnetic gap 42 (second gap) having the height (gap width) go is formed between the main plane 21F12 and the main plane 22F2, that is, in the second outer leg portion 20ZO2.

Further, a magnetic gap 43 (first gap) having a height (gap width) gi is formed between the main plane 21F13 and the main plane 22F2, that is, in the inner leg portion 20ZI.

With the above-described configuration (height HI>height HO), the height gi of the magnetic gap 43 of the inner leg portion 20ZI is smaller than the height go of the magnetic gaps 41 and 42 of the first outer leg portion 20ZO1 and the second outer leg portion 20ZO2 (see FIGS. 4 and 5).

### (Main Conductor 31, Main Conductor 32)

The main conductor 31 and the main conductor 32 have the same shape as each other. However, the same shape here includes a range of a manufacturing error and a range of variation in characteristics of the array-type power inductor 10.

The main conductor 31 and the main conductor 32 are realized by bending a metal plate having a predetermined thickness and a predetermined width. The thickness and width of the main conductor 31 and the main conductor 32 are set based on electrical resistance values of the main conductor 31 and the main conductor 32 which are allowed by specifications of the array-type power inductor 10 and the switching power supply system device 80. The lengths of the main conductor 31 and the main conductor 32 are set based on inductance of the array-type power inductor 10 (the inductor 11 and the inductor 12).

The main conductor 31 has a main portion 310, a first terminal portion 311, and a second terminal portion 312. The first terminal portion 311 is connected to one end in the extending direction of the main portion 310, and the second terminal portion 312 is connected to the other end in the extending direction of the main portion 310. The extending direction of the first terminal portion 311 and the second terminal portion 312 is substantially orthogonal to the extending direction of the main portion 310.

The main conductor 32 has a main portion 320, a first terminal portion 321, and a second terminal portion 322. The first terminal portion 321 is connected to one end in the extending direction of the main portion 320, and the second terminal portion 322 is connected to the other end in the extending direction of the main portion 320. The extending direction of the first terminal portion 321 and the second terminal portion 322 is substantially orthogonal to the extending direction of the main portion 320.

### (Arrangement of Main Conductor 31 and Main Conductor 32 on Magnetic Body 20)

The main conductor 31 is arranged on the magnetic body 20 in a state where the main portion 310 is fitted into the groove 211 of the magnetic body 20. At this time, the first terminal portion 311 is arranged to face the end surface 20E1 of the magnetic body 20 (the end surface 21E1 of the magnetic body 21), and the second terminal portion 312 is arranged to face the end surface 20E2 of the magnetic body 20 (the end surface 21E2 of the magnetic body 21).

The main conductor 32 is arranged on the magnetic body 20 in a state where the main portion 320 is fitted into the groove 212 of the magnetic body 20. At this time, the first terminal portion 321 is arranged to face the end surface 20E1 of the magnetic body 20 (the end surface 21E1 of the magnetic body 21), and the second terminal portion 322 is arranged to face the end surface 20E2 of the magnetic body 20 (the end surface 21E2 of the magnetic body 21).

The array-type power inductor 10 having such a configuration is mounted on a circuit board constituting the switching power supply system device 80 at the tip end portion of the first terminal portion 311 and the tip end portion of the second terminal portion 312 of the main conductor 31 and the tip end portion of the first terminal portion 321 and the tip end portion of the second terminal portion 322 of the main conductor 32.

At this time, the first terminal portion 311 of the main conductor 31 is connected to the output terminal of the power semiconductor IC 81, and the second terminal portion 312 of the main conductor 31 is connected to the Hi-side output terminal of the switching power supply system device 80. Therefore, the first terminal portion 311 of the main conductor 31 or the tip end portion thereof serves as the first input terminal P101 of the array-type power inductor 10, and the second terminal portion 312 of the main conductor 31 or the tip end portion thereof serves as the first output terminal P102 of the array-type power inductor 10.

The first terminal portion 321 of the main conductor 32 is connected to the output terminal of the power semiconductor IC 82, and the second terminal portion 322 of the main conductor 32 is connected to the Hi-side output terminal of the switching power supply system device 80. Therefore, the first terminal portion 321 of the main conductor 32 or the tip end portion thereof serves as the second input terminal P201 of the array-type power inductor 10, and the second terminal portion 322 of the main conductor 32 or the tip end portion thereof serves as the second output terminal P202 of the array-type power inductor 10.

### (Current and Magnetic Flux in Array-Type Power Inductor 10)

FIG. 5 is an enlarged side view showing an example of states of currents and magnetic fluxes in the array-type power inductor according to the first embodiment.

With the above-described configuration, currents flow through the main conductor 31 constituting the inductor 11 and the main conductor 32 constituting the inductor 12 of the array-type power inductor 10 in the same direction (in the direction from the front to the back of the paper surface in FIG. 5, for example).

As a result, a magnetic flux Φ31 forming the self-inductance of the inductor 11 is generated around the main portion Φ10 of the main conductor 31. A magnetic flux Φ32 forming the self-inductance of the inductor 12 is generated around the main portion Φ20 of the main conductor 32.

In the inner leg portion 20ZI between the main conductors 31 and 32 adjacent to each other, the direction of the magnetic flux Φ31 and the direction of the magnetic flux Φ32 are opposite to each other. Accordingly, the magnetic flux Φ31 and the magnetic flux Φ32 create a phenomenon of canceling each other.

On the other hand, in the first outer leg portion 20ZO1 on the side surface 20S1 side where there is no other main conductor adjacent to the main conductor 31, the magnetic flux Φ31 and the magnetic flux Φ32 have the same direction. Therefore, the magnetic flux Φ31 and the magnetic flux Φ32 create a phenomenon of strengthening each other.

Similarly, in the second outer leg portion 20ZO2 on the side surface 20S2 side where there is no other main conductor adjacent to the main conductor 32, the magnetic flux Φ31 and the magnetic flux Φ32 have the same direction. Therefore, the magnetic flux Φ31 and the magnetic flux Φ32 create a phenomenon of strengthening each other.

As a result, as shown in FIG. 5, a magnetic flux Φ33 forming a coupling inductance is generated in a manner to pass through the first outer leg portion 20ZO1 and the second outer leg portion 20ZO2 and not to pass through the inner leg portion 20ZI.

Here, as described above, there is the magnetic body in the inner leg portion 20ZI, and the inner leg portion 20ZI has the magnetic gap 43. There is the magnetic body in the first outer leg portion 20ZO1, and the first outer leg portion 20ZO1 has the magnetic gap 41. There is the magnetic body in the second outer leg portion 20ZO2, and the second outer leg portion 20ZO2 has the magnetic gap 42.

The height go of the magnetic gaps 41 and 42 is larger than the height gi of the magnetic gap 43.

In this configuration, there is the magnetic body in the inner leg portion 20ZI and the height gi of the magnetic gap 43 is smaller, being able to reduce magnetic resistance of a magnetic path (first magnetic path) passing through the inner leg portion 20ZI. Therefore, even in the inner leg portion 20ZI where the magnetic fluxes cancel each other, it is possible to form a magnetic path (first magnetic path) through which the magnetic flux Φ31 which is generated by current i31 flowing through the main conductor 31 and forms the self-inductance of the inductor 11 passes. Similarly, it is possible to form a magnetic path (first magnetic path) through which the magnetic flux Φ32 which is generated by current i32 flowing through the main conductor 32 and forms the self-inductance of the inductor 12 passes. Furthermore, undesired coupling between the magnetic flux Φ31 and the magnetic flux Φ32 is suppressed, whereby the width WI of the inner leg portion 20ZI can be reduced.

In addition, the height go of the magnetic gaps 41 and 42 is larger, whereby magnetic resistance of a magnetic path (second magnetic path) passing through the first outer leg portion 20ZO1 and the second outer leg portion 20ZO2 can be increased. Therefore, magnetic saturation can be suppressed in the first outer leg portion 20ZO1 and the second outer leg portion 20ZO2 where the magnetic fluxes strengthen each other.

As a result, the array-type power inductor 10 can be miniaturized and improved in performance. Furthermore, the main conductor 31 and the main conductor 32 have a linear three dimensional structure which is non-spiral, and the array-type power inductor 10 can accordingly reduce the resistance value of the main conductor 31 and the resistance value of the main conductor 32, being able to reduce the loss. Thus, the array-type power inductor 10 can achieve high efficiency. In particular, in the switching power supply system device 80, high current flows through the inductors 11 and 12. Therefore, by applying the array-type power inductor 10 to the switching power supply system device 80, the switching power supply system device 80 can achieve high efficiency.

Furthermore, in this configuration, the self-inductance and the mutual inductance can be arbitrarily adjusted as a coupled inductor by appropriately adjusting the height go of the magnetic gaps 41 and 42 and the height gi of the magnetic gap 43 while satisfying the relationship gi<go. For example, the magnitude of the magnetic flux density in the first outer leg portion 20ZO1 and the second outer leg portion 20ZO2 and the magnitude of the magnetic flux density in the inner leg portion 20ZI can be made substantially uniform. This makes it possible to appropriately adjust the balance between the self-inductance and the mutual inductance and to minimize the volume of the magnetic body while suppressing magnetic saturation even at the maximum magnetic flux density. Magnetic saturation in an inductor can be suppressed and miniaturization of the inductor can be optimized. As a result, the inductor can be miniaturized, and the components of the power conversion circuit can be miniaturized, thereby realizing a highly efficient, compact, and lightweight switching power supply system.

Thus, the array-type power inductor 10 can simultaneously achieve desired characteristics and miniaturization.

Furthermore, in this configuration, a plurality of inductors can be realized by a single piece of array-type power inductor 10. This makes it possible to reduce a mounting area on a circuit board as compared with the case where a plurality of inductors are formed individually, and, for example, the switching power supply system device 80 can be miniaturized.

Further, by arbitrarily setting the number of main conductors corresponding to winding and the number of inner leg portions of the magnetic body corresponding to the core, an array-type power inductor having a small scalable structure including a magnetic body structure in which the entire structure is integrated can be realized, and scalable correspondence can be made in accordance with a power specification of a power conversion circuit. This exhibits advantageous effects that an inductor structure does not have to be designed for each power specification and a development period and a design period of the switching power supply device can be shortened. In addition, in the development and design of the power conversion circuit, it is not necessary to prepare various inductors based on structures individually designed to meet power specifications, and it is possible to simplify manufacturing management and inventory management of an inductor and to simplify the evaluation of electrical characteristics of the inductor. Thus, the switching power supply device can be improved in efficiency and performance, and can be reduced in cost and improved in reliability in quality.

### Second Embodiment

An array-type power inductor according to a second embodiment of the present disclosure will be described with reference to the drawings. FIG. 6 is an enlarged side view showing an example of a configuration of the array-type power inductor according to the second embodiment of the present disclosure and states of currents and magnetic fluxes in the same.

As shown in FIG. 6, an array-type power inductor 10A according to the second embodiment is different from the array-type power inductor 10 according to the first embodiment in a configuration of a magnetic body 20A. The other configurations of the array-type power inductor 10A are the same as those of the array-type power inductor 10, and the description of the same portions will be omitted.

The magnetic body 20A of the array-type power inductor 10A includes a magnetic body 21A. In the magnetic body 20A, the width WI of the inner leg portion 20ZI is larger than the width WO of the first outer leg portion 20ZO1 and the second outer leg portion 20ZO2 and is smaller than a value twice the width WO (2×WO) (WO<WI<2×WO).

With such a configuration, the array-type power inductor 10A can exhibit the same advantageous effects as those of the array-type power inductor 10, and can further reduce magnetic flux leakage.

In the array-type power inductor 10A, the distance between the main plane 21F13 and the main plane 21F2 is the same as the distances between the main plane 21F11 and the main plane 21F2 and between the main plane 21F12 and the main plane 21F2 in the magnetic body 21A. In other words, the height of the portion formed of the magnetic body 21A in the inner leg portion 20ZI is the same as the heights of the portions formed of the magnetic body 21A in the first outer leg portion 20ZO1 and the second outer leg portion 20ZO2. Therefore, the height gi of the magnetic gap 43 of the inner leg portion 20ZI is the same as the height go of the magnetic gap 41 and the magnetic gap 42 of the first outer leg portion 20ZO1 and the second outer leg portion 20ZO2.

As long as the array-type power inductor 10A has the above-described relationship of WO<WI<2×WO, the array-type power inductor 10A can exhibit the same advantageous effects as those of the array-type power inductor 10 even when setting the height gi of the magnetic gap 43 of the inner leg portion 20ZI and the height go of the magnetic gaps 41 and 42 of the first outer leg portion 20ZO1 and the second outer leg portion 20ZO2 same as each other.

### Third Embodiment

An array-type power inductor according to a third embodiment of the present disclosure will be described with reference to the drawings. FIG. 7 is an enlarged side view showing an example of a configuration of the array-type power inductor according to the third embodiment of the present disclosure and states of currents and magnetic fluxes in the same.

As shown in FIG. 7, an array-type power inductor 10B according to the third embodiment is different from the array-type power inductor 10 according to the first embodiment in a configuration of a magnetic body 20B. The other configurations of the array-type power inductor 10B are the same as those of the array-type power inductor 10, and the description of the same portions will be omitted.

In the array-type power inductor 10B, the magnetic body 21 and the magnetic body 22 abut on each other in the inner leg portion 20ZI. In other words, there is no gap in the inner leg portion 20ZI.

With such a configuration, the array-type power inductor 10B can exhibit the same advantageous effects as those of the array-type power inductor 10.

### Fourth Embodiment

An array-type power inductor according to a fourth embodiment of the present disclosure will be described with reference to the drawings. FIG. 8 is an exploded perspective view of the array-type power inductor according to the fourth embodiment of the present disclosure.

As shown in FIG. 8, an array-type power inductor 10C according to the fourth embodiment is different from the array-type power inductor 10 according to the first embodiment in configurations of a magnetic body 21C and a magnetic body 22C. The other configurations of the array-type power inductor 10C are the same as those of the array-type power inductor 10, and the description of the same portions will be omitted.

In the magnetic body 21C, a distance H between the main plane 21F13 and the main plane 21F2 is the same as a distance H between the main plane 21F11 and the main plane 21F2 and a distance H between the main plane 21F12 and the main plane 21F2. In other words, a height of a portion formed of the magnetic body 21C in the inner leg portion 20ZI is the same as heights of portions formed of the magnetic body 21C in the first outer leg portion 20ZO1 and the second outer leg portion 20ZO2.

The magnetic body 22C has recessed portions 2291 and 2292 which are recessed from the main plane 22F2. The portion where the recessed portion 2291 is formed in the magnetic body 22C faces the main plane 21F11 of the magnetic body 21C. The portion where the recessed portion 2292 is formed in the magnetic body 22C faces the main plane 21F12 of the magnetic body 21C.

With such a configuration in which the recessed portions 2291 and 2292 are formed on the magnetic body 22C, the array-type power inductor 10C can realize a similar configuration as that of the array-type power inductor 10. Accordingly, the array-type power inductor 10C can exhibit the same advantageous effects as those of the array-type power inductor 10.

The material of the magnetic body is not described in detail in the above description, but the magnetic material is preferably a metal-based magnetic material, and particularly, any one of the following materials is more preferably used.

The magnetic material is a Mn—Zn based ferrite material. Accordingly, the magnetic body can achieve high relative magnetic permeability and obtain large inductance while being compact.

The magnetic material is a Mn—Ni based ferrite material. This allows the magnetic body to reduce hysteresis loss in high-frequency operation. Therefore, in application to the switching power supply system device 80, highly efficient power conversion can be realized.

In the configuration of each of the above-described embodiments, the configuration including two main conductors (two inductors) is shown. However, the number of main conductors may be three or more. When three or more main conductors are provided, magnetic body portions (including magnetic gaps) outside both ends of the arranged main conductors (on the side surface sides of the magnetic body) are outer leg portions, and magnetic body portions (including magnetic gaps) between adjacent main conductors are inner leg portions. With such a configuration, in a scalable structure corresponding to the output current of the switching power supply system device 80, the self-inductance and the mutual inductance can be arbitrarily adjusted, and the magnetic components can be miniaturized while obtaining a large inductance.

The configurations of the above-described embodiments can be appropriately combined, and the advantageous effects based on each combination can be achieved.

<1> An array-type power inductor including a plurality of main conductors whose number is at least two and which have a linear three dimensional structure and individually constitute a plurality of inductors, the linear three dimensional structure being non-spiral; a magnetic body which is made of a magnetic material and forms a magnetic path of a magnetic flux, the magnetic flux being generated by currents flowing through the plurality of main conductors; and a plurality of external terminals which are arranged in an outside of the magnetic body and are electrically connected to the plurality of respective main conductors. the plurality of main conductors are arranged in parallel with each other with a structure in which there is the magnetic body in an adjacent inside of each of the plurality of main conductors. the plurality of external terminals are connected to a power conversion circuit in an outside so that directions of the currents flowing through the plurality of main conductors are the same as each other. The magnetic body includes an inner leg portion which is positioned on an inner side and to which the plurality of main conductors are adjacent, and an outer leg portion which is positioned on an outer side and to which the plurality of main conductors are not adjacent. The inner leg portion has a first gap which forms a first magnetic path for a magnetic flux passing through the inner leg portion in magnetic fluxes generated when a current flows through one of the main conductors. The outer leg portion has a second gap which forms a second magnetic path for a magnetic flux passing through the outer leg portion without passing through the inner leg portion in magnetic fluxes generated when a current flows through one of the main conductors. A magnetic body structure is provided which creates a physical phenomenon in which magnetic fluxes generated when currents flow through the plurality of main conductors in a same direction cancel each other in the inner leg portion and strengthen each other in the outer leg portion, and in which magnetic resistance formed by the second gap is larger than magnetic resistance formed by the first gap and an entire structure is integrated including the inner leg portion, the outer leg portion, the first gap, and the second gap, and a structure in which the plurality of inductors are integrated is provided.

<2> The array-type power inductor according to <1>, in which the plurality of inductors have a scalable structure in which an output current obtained by merging currents flowing through the plurality of main conductors is allowed to correspond to a current outputted from the power conversion circuit in the outside by setting the number of the plurality of main conductors and the number of the inner leg portion and the magnetic body structure in which the entire structure is integrated is provided.

<3> The array-type power inductor according to <1> or <2>, in which a width of the inner leg portion, the width of the inner leg portion being an adjacent distance between the plurality of main conductors, is twice or less a width of the outer leg portion, the width of the outer leg portion being a distance between a side surface of the magnetic body and a main conductor closest to the side surface. Also, a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

<4> The array-type power inductor according to any one of <1> to <3>, in which a width of the inner leg portion is larger than or equal to a width of the outer leg portion, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

<5> The array-type power inductor according to any one of <1> to <4>, in which a width of the first gap is smaller than a width of the second gap, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

<6> The array-type power inductor according to any one of <1> to <5>, in which the magnetic material is a Mn—Zn based ferrite material.

<7> The array-type power inductor according to any one of <1> to <5>, in which the magnetic material is a Mn—Ni based ferrite material.

<8> The array-type power inductor according to any one of <1> to <5>, in which the magnetic material is a metal-based magnetic material.

<9> A switching power supply system device including the array-type power inductor according to any one of <1> to <8> ; and a plurality of power conversion circuits each configured using the plurality of inductors.

What is claimed is:

1. An array-type power inductor comprising:
a plurality of main conductors whose number is at least two and which have a linear three dimensional structure and individually configure a plurality of inductors, the linear three dimensional structure being non-spiral;
a magnetic body which includes a magnetic material and defines a magnetic path of a magnetic flux, the magnetic flux being generated by currents flowing through the plurality of main conductors;
a plurality of external terminals which are outside of the magnetic body and are electrically connected to the plurality of respective main conductors; wherein
the plurality of main conductors are in parallel with each other with a structure in which there is the magnetic body in an adjacent inside of each of the plurality of main conductors,
the plurality of external terminals are connected to a power conversion circuit in an outside so that directions of the currents flowing through the plurality of main conductors are the same as each other,
the magnetic body includes
an inner leg portion which is on an inner side and to which the plurality of main conductors are adjacent, and
an outer leg portion which is on an outer side and to which the plurality of main conductors are not adjacent,
the inner leg portion has a first gap which defines a first magnetic path for a magnetic flux passing through the inner leg portion in magnetic fluxes generated when a current flows through one of the main conductors, and
the outer leg portion has a second gap which defines a second magnetic path for a magnetic flux passing through the outer leg portion without passing through the inner leg portion in magnetic fluxes generated when a current flows through one of the main conductors;
a magnetic body structure configured to create a physical phenomenon in which magnetic fluxes generated when currents flow through the plurality of main conductors in a same direction cancel each other in the inner leg portion and strengthen each other in the outer leg portion, and in which magnetic resistance defined by the second gap is larger than magnetic resistance defined by the first gap and an entire structure is integrated including the inner leg portion, the outer leg portion, the first gap, and the second gap; and
a structure in which the plurality of inductors are integrated.

2. The array-type power inductor according to claim 1, wherein
the plurality of inductors have a scalable structure in which an output current obtained by merging currents flowing through the plurality of main conductors corresponds to a current outputted from the power conversion circuit in the outside by setting the number of the plurality of main conductors and the number of the inner leg portion and the magnetic body structure in which the entire structure is integrated.

3. The array-type power inductor according to claim 1, wherein
a width of the inner leg portion, the width of the inner leg portion being an adjacent distance between the plurality of main conductors, is twice or less a width of the outer leg portion, the width of the outer leg portion being a distance between a side surface of the magnetic body and a main conductor closest to the side surface, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

4. The array-type power inductor according to claim 1, wherein
a width of the inner leg portion is larger than or equal to a width of the outer leg portion, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

5. The array-type power inductor according to claim 1, wherein
a width of the first gap is smaller than a width of the second gap, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

6. The array-type power inductor according to claim 1, wherein
the magnetic material is a Mn—Zn based ferrite material.

7. The array-type power inductor according to claim 1, wherein
the magnetic material is a Mn—Ni based ferrite material.

8. The array-type power inductor according to claim 1, wherein
the magnetic material is a metal-based magnetic material.

9. A switching power supply system device comprising:
the array-type power inductor according to claim 1; and
a plurality of power conversion circuits each configured using the plurality of inductors.

10. The array-type power inductor according to claim 1, wherein
a width of the inner leg portion, the width of the inner leg portion being an adjacent distance between the plurality of main conductors, is twice or less a width of the outer leg portion, the width of the outer leg portion being a distance between a side surface of the magnetic body and a main conductor closest to the side surface, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

11. The array-type power inductor according to claim 2, wherein
a width of the inner leg portion is larger than or equal to a width of the outer leg portion, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

12. The array-type power inductor according to claim 3, wherein
a width of the inner leg portion is larger than or equal to a width of the outer leg portion, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

13. The array-type power inductor according to claim 2, wherein
a width of the first gap is smaller than a width of the second gap, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

14. The array-type power inductor according to claim 3, wherein
a width of the first gap is smaller than a width of the second gap, and a magnitude of magnetic flux density in the inner leg portion in the first magnetic path and a magnitude of magnetic flux density in the outer leg portion in the second magnetic path are substantially uniform with respect to a magnetic flux generated by currents flowing through the plurality of main conductors in the same direction.

15. The array-type power inductor according to claim 2, wherein
the magnetic material is a Mn—Zn based ferrite material.

16. The array-type power inductor according to claim 3, wherein
the magnetic material is a Mn—Zn based ferrite material.

17. The array-type power inductor according to claim 2, wherein
the magnetic material is a Mn—Ni based ferrite material.

18. The array-type power inductor according to claim 3, wherein
the magnetic material is a Mn—Ni based ferrite material.

19. The array-type power inductor according to claim 2, wherein
the magnetic material is a metal-based magnetic material.

20. A switching power supply system device comprising:
the array-type power inductor according to claim 2; and
a plurality of power conversion circuits each configured using the plurality of inductors.
